(19) United States
(12) Patent Application Publication
(10) Pub. No.: US 2010/0316881 A1
(43) Pub. Date: Dec. 16, 2010

(54) METHOD OF REDUCING MAPPING OF AN ELECTRODEPOSITABLE COATING LAYER

(76) Inventors: Alan J. Kaylo, Glenshaw, PA (US); Donald W. Boyd, Cheswick, PA (US); Garry R. Grant, Olmstead Falls, OH (US)

Correspondence Address: PPG INDUSTRIES INC;INTELLECTUAL PROPERTY DEPT, ONE PPG PLACE, PITTSBURGH, PA, 15272, US

(21) Appl. No.: 12/813,544

(22) Filed: Jun. 11, 2010

Related U.S. Application Data
(60) Provisional application No. 61/187,298, filed on Jun. 16, 2009.

(51) Int. Cl. B32B 15/04; C25D 5/10

(52) U.S. Cl. 428/545; 205/114

(57) ABSTRACT

The present invention is directed to a method for coating a substrate with a variety of coating compositions thereby reducing mapping of a coating composition deposited onto the substrate. In certain embodiments, the present invention is directed to the deposition of a zirconium based pretreatment composition onto a substrate with the subsequent deposition of an electrodepositable coating composition, which comprises a soluble alkaline earth metal ion, onto the pretreatment composition. The present invention is also directed to a coating system comprising various layers deposited from the coating compositions disclosed herein.

### CROSS REFERENCE TO RELATED APPLICATIONS

This application claims benefit of U.S. Provisional Application No. 61/187,298 filed Jun. 16, 2009, which is incorporated herein by reference.

### FIELD OF THE INVENTION

The present invention relates to a method of reducing mapping of a coating layer deposited onto a substrate.

### BACKGROUND INFORMATION

In the Automotive and Industrial OEM industries, a substrate is typically pretreated with a pretreatment coating composition and rinsed with a rinsing solution, such as deionized water, prior to application of an electrodepositable coating composition onto the substrate. While the pretreatment coating composition is applied onto the substrate to increase the adhesion of subsequently deposited coatings, one of the potential drawbacks of using certain types of pretreatment coating compositions is that it can lead to “mapping” in the electrodepositable coating layer that is deposited from an electrodepositable coating composition. “Mapping” is the phenomenon that occurs when topcoats are subsequently applied to such electrodepositable coating layer and the differences in film thickness of the electrodeposition coating layer can telegraph through the topcoats, thereby creating an undesirable topcoat appearance.

### SUMMARY OF THE INVENTION

The present invention is directed to a method of coating a substrate comprising: depositing a first coating composition onto at least a portion of the substrate, said first coating composition comprising: (i) a group IIIB metal, a group IVB metal, or combinations thereof; depositing a second coating composition onto at least a portion of the first coating composition, said second coating composition comprising: (a) an active hydrogen containing ionic salt group containing resin comprising reactive functional groups; (b) a crosslinking agent reactive with at least one of the reactive functional groups of the resin; and (c) a soluble alkaline earth metal present in an amount of not more than 1000 parts per million, based on the total weight of the second coating composition.

The present invention is also directed to a coating system comprising: a first coating layer deposited onto at least a portion of a substrate wherein said first coating layer is deposited from a first coating composition comprising: (i) a group IIIB metal, a group IVB metal, or combinations thereof; and a second coating layer deposited onto at least a portion of the first coating layer wherein said second coating layer is deposited from a second coating composition comprising: (a) an active hydrogen containing ionic salt group containing resin comprising reactive functional groups; (b) a crosslinking agent reactive with at least one of the reactive functional groups of the resin; and (c) a soluble alkaline earth metal present in an amount of not more than 1000 parts per million, based on the total weight of the second coating composition.

### DETAILED DESCRIPTION

As used herein, unless otherwise expressly specified, all numbers such as those expressing values, ranges, amounts or percentages may be read as if prefaced by the word “about”, even if the term does not expressly appear. When referring to any numerical range of values, such ranges are understood to include each and every number and/or fraction between the stated range minimum and maximum. For example, a range of “1 to 10” is intended to include all sub-ranges between (and including) the recited minimum value of 1 and the recited maximum value of 10, that is, having a minimum value equal to or greater than 1 and a maximum value of equal to or less than 10. As employed herein, the term “number” means one or an integer greater than one.

As used herein, plural phrases or terms encompasses their singular counterparts and vice versa, unless specifically stated otherwise. By way of illustration, and not limitation, although reference is made herein to “a” soluble rare earth metal, a plurality of these rare earth metals may be used in the present invention. As used herein, “plurality” means two or more.

As used herein, “includes” and like terms means “including without limitation.”

As used herein, the use of “or” means “and/or” unless specifically stated otherwise, even though “and/or” may be explicitly used in certain instances.

As used herein, “molecular weight” means weight average molecular weight (Mw) as determined by Gel Permeation Chromatography.

As used herein, the term “cure” refers to a coating wherein any crosslinkable components of the composition are at least partially crosslinked. In certain embodiments, the crosslink density of the crosslinkable components (i.e., the degree of crosslinking) ranges from 5% to 100%, such as 35% to 85%, or, in some cases, 50% to 85% of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen.

Reference to any monomer(s) herein refers generally to a monomer that can be polymerized with another polymerizable component such as another monomer or polymer. Unless otherwise indicated, it should be appreciated that once the monomer components react with one another to form a compound, the compound will comprise the residues of the monomer components.

As used herein, a “substantially solvent free environment” means that trace or incidental amounts of organic solvent, such as ≦5 weight % or ≦3 weight % or ≦1 weight % based on all of the ingredients used in the reaction mixture, can be present.

### Method of Coating a Substrate

The present invention is directed to a method of applying various coating compositions onto a surface of substrate. The various coating composition disclosed herein, in some instances, are selected to reduce and/or eliminate the “mapping” effect described above.

In certain embodiments, the present invention is directed to a method of coating a substrate comprising: (1) depositing a first coating composition onto at least a portion of the substrate, said first coating composition comprising: (i) a group IIIB metal, a group IVB metal, or combinations thereof; and (2) depositing a second coating composition onto at least a portion of the first coating composition, said second coating composition comprising: (a) an active hydrogen containing ionic salt group containing resin comprising reactive functional groups; (b) a crosslinking agent reactive with at least one of the reactive functional groups of the resin; and (c) a soluble alkaline earth metal ion present in an amount of not more than 1000 parts per million, based on the total weight of the second coating composition.

The substrate to be coated in accordance with the methods of the present invention may first be cleaned to remove grease, dirt, or other extraneous matter using techniques known in the art. For example, mild or strong alkaline cleaners, which are commercially available and conventionally used in metal pretreatment processes, can be used to clean at least a portion of the surface of the substrate. Examples of alkaline cleaners suitable for use in the present invention include Chemkleen 166HP and Chemkleen 2010LP, both of which are commercially available from PPG Industries, Inc. Such cleaners are often followed and/or preceded by a rinsing step in which a rinsing solution, such as water (including deionized water), is applied onto the substrate.

### First Coating Composition:

As described above, the method of the present invention entails depositing a first coating composition onto at least a portion of the substrate. In certain embodiments, the first coating composition is a pretreatment coating composition. As used herein, “pretreatment coating composition” refers to a composition that chemically alters the surface of a bare metal substrate. The first coating composition comprises: (i) a group IIIB metal, a group IVB metal, or a combination thereof. As used herein, the terms “group IIIB metal” and “group IVB metal” refer to the elements that are in group IIIB and group IVB of the CAS Periodic Table of Elements as shown, for example in the Handbook of Chemistry and Physics, 63rd edition (1983). As used herein, the term “group IIIB metal compound” or “group IVB metal compound” refers to compounds that comprise at least one element that is in group IIIB or group IVB of the CAS Periodic Table of Elements. While, in certain embodiments, the source of the IIIB and/or IVB metal is the metal itself (e.g., zirconium, titanium, hafnium, yttrium, cerium, or combinations thereof), group IIIB and/or IVB compounds may also be used as the source of the IIIB and/or IVB metal. Suitable IIIB and/or IVB compounds include hexafluorozirconic acid, alkali metal and ammonium salts thereof, ammonium zirconium carbonate, zirconyl nitrate, zirconium carboxylates and zirconium hydroxy carboxylates, such as hydrofluorozirconic acid, zirconium acetate, zirconium oxalate, ammonium zirconium glycolate, ammonium zirconium lactate, ammonium zirconium citrate, fluorotitanic acid and its salts, hafnium nitrate, yttrium nitrate, cerous nitrate, or combinations thereof.

In certain embodiments, the group IIIB and/or group IVB metal compound is present in the first coating composition in an amount of 10 to 5000 parts per million (“ppm”) metal, such as 100 to 300 ppm metal, based on the total weight of the first coating composition. The pH of the first coating composition often ranges from 2.0 to 7.0, such as 3.5 to 5.5. The pH of the first coating composition may be adjusted using mineral acids, such as hydrofluoric acid, fluoroboric acid, phosphoric acid, and the like, including mixtures thereof; organic acids, such as lactic acid, acetic acid, citric acid, or mixtures thereof; and water soluble or water dispersible bases, such as sodium hydroxide, ammonium hydroxide, ammonia, or amines, such as triethylamine, methylethyl amine, diisopropanolamine, or a mixture thereof.

In certain embodiments, the first coating composition also comprises a copper compound. While, in some embodiments, the source of copper in the copper compound is the metal itself, both water soluble and insoluble copper compounds may be used as the source of the copper compound in the first coating composition. As used herein, “copper compound” refers to compounds that comprise copper. Suitable water soluble and/or water insoluble copper compounds include copper cyanide, copper potassium cyanide, copper sulfate, copper nitrate, copper pyrophosphate, copper thiocyanate, disodium copper ethylenediaminetetraacetate tetrahydrate, copper bromide, copper oxide, copper hydroxide, copper chloride, copper fluoride, copper gluconate, copper citrate, copper lauroyl sarcosinate, copper formate, copper acetate, copper propionate, copper butyrate, copper lactate, copper oxalate, copper phytate, copper tartarate, copper malate, copper succinate, copper malonate, copper maleate, copper benzoate, copper salicylate, copper aspartate, copper glutamate, copper fumarate, copper glycerophosphate, sodium copper chlorophyllin, copper fluorosilicate, copper fluoroborate and copper iodate, as well as copper salts of carboxylic acids in the homologous series formic acid to decanoic acid, copper salts of polybasic acids in the series oxalic acid to suberic acid, and copper salts of hydroxycarboxylic acids, including glycolic, lactic, tartaric, malic and citric acids, or combinations in any of the foregoing. In certain embodiments, the copper compound is added as a complex salt such as those described in U.S. Patent Publication No. 2009/0084682 in paragraph [0020], the cited portion of which being incorporated herein by reference.

When copper ions supplied from such a water-soluble copper compound are precipitated as an impurity in the form of copper sulfate, copper oxide, etc., it may be desirable to add a complexing agent that suppresses the precipitation of copper ions, thus stabilising them as a copper complex in the solution. Suitable complexing agents include those described in U.S. Patent Publication No. 2009/0084682 in paragraph [0021], the cited portion of which being incorporated herein by reference.

In certain embodiments, the copper compound is included in the first coating composition in an amount from 1 ppm to 5,000 ppm, such as 1 ppm to 500 ppm, or, in some cases, 1 ppm to 50 ppm of total copper (measured as elemental copper), based on the total weight of the ingredients in the first coating composition.

In some embodiments, the first coating composition can also comprise the various materials, such as the binder, and surfactants as described in paragraphs [0025] to [0028] of U.S. Patent Publication No. 2008/0145678, which is incorporated herein by reference.

In certain embodiments, the first coating composition also comprises a silane, such as, for example, an amino group-containing silane coupling agent, a hydrolysate thereof, or a polymer thereof, as described in U.S. Patent Publication No. 2004/0163736 at [0025] to [0031], the cited portion of which being incorporated herein by reference. In other embodiments of the present invention, however, the first coating composition is substantially free, or, in some cases, completely free of any such amino group-containing silane coupling agent. As used herein, the term “substantially free”, when used with reference to the absence of amino-group containing silane coupling agent in the first coating composition, means that any amino-group containing silane coupling agent, hydrolysate thereof, or polymer thereof that is present in the pretreatment composition is present in an amount of less than 5 ppm. As used herein, the term “completely free” means that there is no amino-group containing silane coupling agent, hydrolysate thereof, or polymer thereof in the first coating composition at all.

In certain embodiments, the first coating composition also comprises a reaction accelerator, such as nitrite ions, nitro-group containing compounds, hydroxylamine sulfate, persulfate ions, sulfite ions, hyposulfite ions, peroxides, iron (III) ions, citric acid iron compounds, bromate ions, perchlorinate ions, chlorate ions, chlorite ions as well as ascorbic acid, citric acid, tartaric acid, malonic acid, succinic acid and salts thereof, or combinations thereof. Specific examples of suitable materials and their amounts are described in U.S. Patent Publication No. 2004/0163736 in paragraphs [0032] to [0041], the cited portion of which being incorporated herein by reference.

In certain embodiments, the first coating composition also includes a source of phosphate ions. Suitable amounts of phosphate ions and suitable sources of such ions are described in U.S. Patent Publication No. 2009/0032144 in paragraph [0043], the cited portion of which being incorporated herein by reference. In other embodiments, however, the first coating composition is substantially or, in some cases, completely free of phosphate ions. As used herein, the term “substantially free” when used in reference to the absence of phosphate ions in the first coating composition, means that phosphate ion is present in the composition in an amount of less than 10 ppm based on the total weight of the first coating composition. As used herein, “completely free”, when used with reference to the absence of phosphate ions, means that there are no phosphate ions in the first coating composition at all.

In certain embodiments, the first coating composition is substantially or, in some cases, completely free of chromate and/or heavy metal phosphate, such as zinc phosphate. As used herein, the term “substantially free” when used in reference to the absence of chromate and/or heavy metal phosphate in the pretreatment composition, means that these substances are present in an amount of less than 10 ppm based on the total weight of the first coating composition. As used herein, the term “completely free”, when used with reference to the absence of a heavy metal phosphate and/or chromate, means that there is no heavy metal phosphate and/or chromate in the first coating composition at all.

Moreover, in certain embodiments, the first coating composition is substantially free, or, in some cases, completely free of any organic materials. As used herein, the term “substantially free”, when used with reference to the absence of organic materials in the composition, means that any organic materials are present in the composition, if at all, as an incidental impurity. In other words, the presence of any organic material does not affect the properties of the composition. As used herein, the term “completely free”, when used with reference to the absence of organic material, means that there is no organic material in the composition at all.

In some embodiments, the first coating composition further comprises (iii) free fluorine and (iv) a metal fluoride salt formed from a metal and/or metal compound which forms a fluoride salt. The metal that forms the metal fluoride salt is supplied in an amount sufficient to maintain the level of free fluorine in the first coating composition at a level ranging from 0.1 ppm to 300 ppm based on the total weight of the first coating composition. As used herein, “free fluorine” means isolated fluorine ion and its concentration in the first coating composition. Suitable sources of fluorine include those described in U.S. Patent Publication No. 2009/0032144 in paragraphs [0027] to [0028], the cited portion of which being incorporated herein by reference. In some embodiments, the metal fluoride salt that is formed has a pKsp of at least 11, such as at least 15 or at least 20. As used herein, “pKₛₚ” refers to the inerse log of the solubility product constant for a compound. In the present invention, a metal and/or metal containing compound is selected such that it forms a fluoride salt having a pKₛₚ of at least 11. For purposes of this invention, the pKₛₚ value for a metal fluoride salt refers to the pKₛₚ values reported in Lange's Handbook of Chemistry, 15th Ed., McGraw-Hill, 1999, Table 8.6. In certain embodiments, the metal and/or metal compound which forms a fluoride salt having a pKₛₚ of at least 11 is selected from cerium (pKₛₚ of CeF₃ is 15.1), lanthanum (pKₛₚ of LaF₃ is 16.2), scandium (pKₛₚ of ScF₃ is 23.24), yttrium (pKₛₚ of Y₃ is 20.06), or mixture thereof. In certain embodiments, the metal and/or metal compound can be present in the first coating composition in an amount ranging from 0.1 ppm to 300 ppm, such as from 20 ppm to 100 ppm.

In some embodiments, the first coating composition can further comprise a yttrium containing compound such as those described in U.S. Patent Publication No. 2009/0032144 in paragraph [0033], the cited portion of which being incorporated herein by reference.

Additionally, in certain embodiments, the first coating composition can comprise one or more additional “electropositive metals” as described in U.S. Patent Publication No. 2009/0084682 in paragraphs [0014] to [0015], the cited portion of which being incorporated herein by reference.

After application of the first coating composition on at least a portion of the substrate, the first coating composition can, optionally, be rinsed with water, such as deionized water. Alternatively, at least a portion of the first coating composition, immediately or after a drying period at ambient or elevated temperature conditions, may be coated with the second coating composition described below.

### Second Coating Composition:

As stated above, the present invention also includes the deposition of a second coating composition onto at least a portion of the first coating composition. The second coating composition comprises (a) an active hydrogen containing ionic salt group containing resin comprising reactive functional groups; (b) a crosslinking agent reactive with at least one of the reactive functional groups of the resin; and (c) a soluble alkaline earth metal ion present in an amount of not more than 1000 ppm, such as from 5 ppm to 750 ppm, 5 ppm to 500 ppm, or 5 ppm to 100 ppm, based on the total weight of the second coating composition. As used herein, “an alkaline earth metal ion” means a metal ion of a Group IIA metal, such as Ba²⁺, Sr²⁺, Mg²⁺, Ca²⁺, Be²⁺ or Ra²⁺. More preferably, “an alkaline earth metal ion” means a metal ion of a Group IIA metal such as Ba²⁺ or Sr²⁺ or mixtures thereof. In certain embodiments, the alkaline earth metal ion results from the dissociation of a metal compound, such as a soluble metal compound, in an aqueous medium (e.g., electrodeposition bath). As used herein, “soluble metal compound” refers to a metal compound, typically an alkaline earth metal compound, capable of substantially complete dissociation in an aqueous medium. Examples of suitable soluble metal compounds that may be used in the present invention include those listed in U.S. Patent Publication No. 2004/0050704 in paragraph [0018], the cited portion of which being incorporated herein by reference.

In some embodiments, the second composition can further comprise “insoluble metal compounds” such as those listed in U.S. Patent Publication No. 2004/0050704 in paragraph [0018]. As used herein, “insoluble metal compound” refers to a metal compound, typically a rare earth metal compound, capable of only partial dissociation in an aqueous medium.

In certain embodiments, the second coating composition can further comprise additional metal compounds, which may be advantageous in minimizing “mapping,” such as those described in U.S. Patent Publication No. 2004/0050704 in paragraph [0019], the cited portion of which being incorporated herein by reference.

In certain embodiments, the second coating composition can further comprise a corrosion inhibitor based on compounds containing metals such as yttrium, bismuth, zinc, cerium, aluminum, silicon, calcium, rare earth elements, and magnesium. These corrosion inhibitors may be present in an amount between about 50 and 10,000 ppm total metal based on the total weight of the second coating composition.

In addition to those components described above, the second coating composition can further comprise the main film-forming polymer (e.g., active hydrogen containing polymer), curing agent (i.e., crosslinking agent), and bismuth compound(s), described in U.S. Patent Publication No. 2004/0050704 in paragraphs [0021] to [0033], the cited portion of which being incorporated herein by reference. As used herein, the phrase “reactive functional group” of the active hydrogen containing polymer means hydroxyl, carboxyl, carbamate, epoxy, isocyanate, aceto acetate, amine, mercaptan, or combinations thereof. Suitable crosslinking agents, in addition to the ones referred to above, also include polyepoxides, beta-hydroxyalkylamides, polyacids, anhydrides, organometallic acid-functional materials, polyamines, polyamides, cyclic carbonates, siloxanes, or combinations thereof.

In certain embodiments, the second coating composition is an electrodeposition coating composition that is contained forms at least a portion of an electrodepositable bath. The electrodepositable bath disclosed herein is typically supplied as two components: (1) a main vehicle (“clear resin feed”) and (2) a grind vehicle (“pigment paste”). In general, (1) the main vehicle comprises (a) a film forming polymer (“an active hydrogen-containing ionic salt group-containing resin”), (b) a crosslinking agent, and (c) any additional water-dispersible, non-pigmented components (e.g., catalysts, hindered amine light stabilizers). In general, (2) the grind vehicle comprises (d) one or more pigments (e.g., titanium dioxide, carbon black), (e) a water-dispersible grind resin, which can be the same or different from the film forming polymer, and, optionally, (f) additives such as catalysts, antioxidants, biocides, defoamers, surfactants, wetting agents, dispersing aids, clays, hindered amine light stabilizers, UV light absorbers and stabilizers, or combinations thereof. The electrodeposition bath is typically prepared by dispersing components (1) and (2) in an aqueous medium which comprises water and, usually, coalescing solvents. Alternatively, components (1) and (2) may also be provided as a single component.

### Coating System

The coating compositions disclosed herein may be applied alone or as part of a coating system that can be deposited onto a number of different substrates. The coating system typically comprises a number of coating layers. A coating layer is typically formed when a coating composition that is deposited onto the substrate is substantially cured, dehydrated, and/or dried using methods known in the art (e.g., by thermal heating or via infrared radiation).

Suitable substrates that can be coated with the coating composition disclosed herein include metal substrates, metal alloy substrates, and/or substrates that have been metallized, such as nickel plated plastic. In some embodiments, the metal or metal alloy can be aluminum and/or steel. For example, the steel substrate could be cold rolled steel, electrogalvanized steel, and hot dipped galvanized steel. Moreover, in some embodiments, the substrate may comprise a portion of a vehicle such as a vehicular body (e.g., without limitation, door, body panel, trunk deck lid, roof panel, hood, and/or roof) and/or a vehicular frame. As used herein, “vehicle” or variations thereof includes, but is not limited to, civilian, commercial, and military land vehicles such as cars, motorcycles, and trucks.

In certain embodiments, the first coating composition is applied onto at least a portion of a surface of a substrate that has been cleaned with an alkaline cleaner that is known in the art. An example of a suitable alkaline cleaner that may be used in the present invention includes CHEMKLEEN (commercially available from PPG Industries, Inc.). In some embodiments, at least a portion of the alkaline cleaner is rinsed with an aqueous solution (e.g., dionized water) prior to application of the first coating composition.

After application of the second coating composition disclosed herein, a primer-surfacer coating composition is typically applied onto at least a portion of the second coating composition or second coating layer. The primer-surfacer coating composition is typically applied and cured prior to a subsequent coating composition being applied over the primer-surfacer coating composition.

The primer-surfacer layer that results from the primer-surfacer coating composition serves to enhance chip resistance of the coating system as well as aid in the appearance of subsequently applied layers (e.g., color imparting coating composition and/or substantially clear coating composition). As used herein, “primer-surfacer” refers to a primer composition for use under a subsequently applied coating composition, and includes such materials as thermoplastic and/or crosslinking (e.g., thermosetting) film-forming resins generally known in the art of organic coating compositions. Suitable primers and primer-surfacer coating compositions include spray applied primers, as are known to those skilled in the art. Examples of suitable primers include several available from PPG Industries, Inc., Pittsburgh, Pa., as DPX-1791, DPX-1804, DSPX-1537, GPXH-5379, OPP-2645, PCV-70118, and 1177-225A. Another suitable primer-surfacer coating composition that can be utilized in the present invention is the primer-surfacer described in U.S. patent application Ser. No. 11/773,482.

It should be noted that in some embodiments, the primer-surfacer coating composition is not used in the coating system. Therefore, a color imparting basecoat coating composition can be applied directly onto the second coating composition or the second coating layer described above.

In some embodiments, a color imparting coating composition (hereinafter, “basecoat”) is deposited onto at least a portion of the primer surfacer coating layer (if present). Any basecoat coating composition known in the art may be used in the present invention. It should be noted that these basecoat coating compositions typically comprise a colorant.

In certain embodiments, a substantially clear coating composition (hereinafter, “clearcoat”) is deposited onto at least a portion of the basecoat coating layer. As used herein, a “substantially clear” coating composition is substantially transparent and not opaque when cured. In certain embodiments, the substantially clear coating composition can comprise a colorant but not in an amount such as to render the clear coating composition opaque (not substantially transparent) after it has been cured. Any clearcoat coating composition known in the art may be used in the present invention. For example, the clearcoat coating composition that is described in U.S. Pat. Nos. 5,989,642, 6,245,855, 6,387,519, and 7,005,472 can be used in the coating system. In certain embodiments, the substantially clear coating composition can also comprise a particle, such as a silica particle, that is dispersed in the clearcoat coating composition (such as at the surface of the clearcoat coating composition after curing).

One or more of the coating compositions described herein can comprise colorants and/or other optional materials, which are known in the art of formulated surface coatings. As used herein, the term “colorant” means any substance that imparts color and/or other opacity and/or other visual effect to the composition. The colorant can be added to the coating in any suitable form, such as discrete particles, dispersions, solutions and/or flakes (e.g., aluminum flakes). A single colorant or a mixture of two or more colorants can be used in the coating composition described herein.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which discreet “composite microparticles”, which comprise a nanoparticle and a resin coating on the nanoparticle, is dispersed. Example dispersions of resin-coated nanoparticles and methods for making them are identified in U.S. Patent Publication 2005/0287348, filed Jun. 24, 2004, U.S. Provisional Application No. 60/482,167 filed Jun. 24, 2003, and U.S. patent application Ser. No. 11/337,062, filed Jan. 20, 2006.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating composition described herein. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. patent application Ser. No. 10/892,919, filed Jul. 16, 2004.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The coating compositions can comprise other optional materials well known in the art of formulated surface coatings, such as plasticizers, anti-oxidants, hindered amine light stabilizers, UV light absorbers and stabilizers, surfactants, flow control agents, thixotropic agents such as bentonite clay, pigments, fillers, organic cosolvents, catalysts, including phosphonic acids and other customary auxiliaries.

In addition to the materials described above, the coating composition can also comprise an organic solvent. Suitable organic solvents that can be used in the coating composition include any of those listed in the preceding paragraphs as well as butyl acetate, xylene, methyl ethyl ketone, or combinations thereof.

It will be further appreciated that one or more of the coating compositions that form the various coating layers described herein can be either “one component” (“1K”), “two component” (“2K”), or even multi-component compositions. A 1K composition will be understood as referring to a composition wherein all of the coating components are maintained in the same container after manufacture, during storage, etc. A 2K composition or multi-component composition will be understood as referring to a composition wherein various components are maintained separately until just prior to application. A 1K or 2K coating composition can be applied to a substrate and cured by any conventional means, such as by heating, forced air, and the like.

The coating compositions that form the various coating layers described herein can be deposited or applied onto the substrate using any technique that is known in the art. For example, the coating compositions can be applied to the substrate by any of a variety of methods including, without limitation, spraying, brushing, dipping, and/or roll coating, among other methods. When a plurality of coating compositions are applied onto a substrate, it should be noted that one coating composition may be applied onto at least a portion of an underlying coating composition either after the underlying coating composition has been cured or prior to the underlying coating composition being cured. If the coating composition is applied onto an underlying coating composition that has not been cured, both coating compositions may be cured simultaneously.

The coating compositions may be cured using any technique known in the art such as, without limitation, thermal energy, infrared, ionizing or actinic radiation, or by any combination thereof. In certain embodiments, the curing operation can be carried out at temperatures ≧10° C. In other embodiments, the curing operation can be carried out at temperature ≦246° C. In certain embodiments, the curing operation can carried out at temperatures ranging between any combination of values, which were recited in the preceding sentences, inclusive of the recited values. For example, the curing operation can be carried out at temperatures ranging from 120° C.-150° C. It should be noted, however, that lower or higher temperatures may be used as necessary to activate the curing mechanisms.

In certain embodiments, one or more of the coating compositions described herein is a low temperature, moisture curable coating compositions. As used herein, the term “low temperature, moisture curable” refers to coating compositions that, following application to a substrate, are capable of curing in the presence of ambient air, the air having a relative humidity of 10% to 100%, such as 25% to 80%, and a temperature in the range of −10° C. to 120° C., such as 5° C. to 80° C., in some cases 10° C. to 60° C. and, in yet other cases, 15° C. to 40° C.

The dry film thickness of the coating layers described herein can range from 0.1 micron to 500 microns. In other embodiments, the dry film thickness can be ≦125 microns, such as ≦80 microns. For example, the dry film thickness can range from 15 microns to 60 microns.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### EXAMPLES

### Example A (Comparative Example)

This comparative example describes the preparation of a cationic electrodeposition paint containing no added barium. The electrodeposition paint composition was prepared from a mixture of the following ingredients:

| | |
|---|---|
| Resin blend¹ | 1824 g |
| Pigment paste² | 223 g |
| Deionized water | 1753 g |

¹Cationic resin blend commercially available as E6358 from PPG Ind.
²A pigment paste commercially available as E6364 from PPG Ind.

### Example B

This example describes the preparation of a cationic electrodeposition paint containing 25 ppm barium metal to control mapping defects. The electrodeposition paint composition was prepared from a mixture of the following ingredients:

| | | |
|---|---|---|
| Resin blend¹ | 1824 | g |
| Pigment paste² | 223 | g |
| Deionized water | 1735.2 | g |
| 1% barium nitrate | 17.8 | g |

¹Cationic resin blend commercially available as E6358 from PPG Ind.
²A pigment paste commercially available as E6364 from PPG Ind.

### Example C

Unpolished, cold-rolled steel panels (4×12×032) commercially available from ACT Laboratories, Inc. were cleaned with Chemkleen CK2010LP/CK181LP (Degreasing commercially available from PPG Ind.) and treated with Zircobond® (Zircobond pretreatment commercially available from PPG Ind.). Phosphated panels (4×12×032) commercially available from ACT Laboratories, Inc., C700 No Chemseal Immersion DIW, were used as is. Each one of the pretreated panels was connected together, back to back, on the cathode. Together, they were electrocoated with the composition of Example A for 2′/180 volts/90° F., and cured at 350° F. for 25 minutes.

### Example D

Unpolished, cold-rolled steel panels (4×12×032) commercially available from ACT Laboratories, Inc. were cleaned with Chemkleen CK2010LP/CK181LP (Degreasing commercially available from PPG Ind.) and treated with Zircobond® (Zircobond pretreatment commercially available from PPG Ind.). Phosphated panels (4×12×032) commercially available from ACT Laboratories, Inc., C700 No Chemseal Immersion DIW, were used as is. Each one of the pretreated panels was connected together, back to back, on the cathode. Together, they were electrocoated with the composition of Example B for 2′/180 volts/90° F., and cured at 350° F. for 25 minutes.

### Mapping Results

When the difference in the film build between two differently treated substrates approaches 0, mapping is improved, and the coating is less prone to have uneven film build on the zirconium treated substrate. As shown below, the film thickness difference was smaller in Example D than in Example C, therein indicating the inclusion of 1% barium nitrate to the coating composition improved mapping.

Measured film build (mils)

| | C700 | | Film |
|---|---|---|---|
| | phosphate | Zirconium | thickness |
| | steel | steel | difference |
| Example C | 0.89 | 0.58 | 0.31 |
| Example D | 0.79 | 0.69 | 0.19 |

1. A coating system comprising:
a first coating layer deposited onto at least a portion of a substrate wherein said first coating layer is deposited from a first coating composition comprising: (i) a group IIIB metal compound, a group IVB metal compound, or combinations thereof; and
a second coating layer deposited onto at least a portion of the first coating layer wherein said second coating layer is deposited from a second coating composition comprising: (a) an active hydrogen containing ionic salt group containing resin comprising reactive functional groups; (b) a crosslinking agent reactive with at least one of the reactive functional groups of the resin; and (c) a soluble alkaline earth metal ion present in an amount of not more than 1000 parts per million, based on the total weight of the second coating composition.

2. The coating system according to claim 1, wherein the (c) a soluble alkaline earth metal ion comprises magnesium, strontium, barium, or mixtures thereof.

3. The coating system according to claim 1, wherein a source of the (c) a soluble alkaline earth metal ion is a soluble metal compound derived from a metal selected from magnesium, strontium, barium, or mixtures thereof.

4. The coating system according to claim 1, wherein the second coating composition comprises a corrosion inhibitor.

5. The coating system according to claim 4, wherein the corrosion inhibitor comprises one or more metal compounds containing metal selected from the group consisting yttrium, bismuth, zinc, cerium, aluminum, silicon, calcium, rare earth elements, and magnesium.

6. The coating system according to claim 1, wherein the first coating composition further comprises (iii) free fluorine and (iv) a metal fluoride salt formed from a metal which forms a fluoride salt; wherein the metal that forms the metal fluoride salt is supplied in an amount sufficient to maintain the level of free fluorine in the first coating composition at a level ranging from 0.1 ppm to 300 ppm based on the total weight of the first coating composition.

7. The coating system according to claim 1, wherein the (i) group IIIB or IVB metal comprises zirconium, titanium, hafnium, yttrium, cerium, or combinations thereof.

8. The coating system according to claim 1, wherein said second coating composition further comprises (ii) a copper compound.

9. The coating system according to claim 8, wherein a source of the copper comprising said copper compound (ii) is a water soluble copper compound.

10. The coating system according to claim 8, wherein the copper compound is elemental copper present at a level ranging from 1 ppm to 5,000 ppm based on the total weight of the first coating composition.

11. The coating system according to claim 1, wherein the first coating composition is substantially free of phosphate ions.

12. A method of coating a substrate comprising:
depositing a first coating composition onto at least a portion of the substrate, said first coating composition comprising: (i) a group IIIB metal compound, a group IVB metal compound, or combinations thereof;
depositing a second coating composition onto at least a portion of the first coating composition, said second coating composition comprising: (a) an active hydrogen containing ionic salt group containing resin comprising reactive functional groups; (b) a crosslinking agent reactive with at least one of the reactive functional groups of the resin; and (c) a soluble alkaline earth metal present in an amount of not more than 1000 parts per million, based on the total weight of the second coating composition.

13. The method according to claim 12, wherein the (c) a soluble alkaline earth metal ion comprises magnesium, strontium, barium, or mixtures thereof.

14. The method according to claim 12, wherein a source of the (c) a soluble alkaline earth metal ion is a soluble metal compound derived from a metal selected from magnesium, strontium, barium, or mixtures thereof.

15. The method according to claim 12, wherein the second coating composition comprises a corrosion inhibitor.

16. The method according to claim 15, wherein the corrosion inhibitor comprises one or more metal compounds containing metal selected from the group consisting yttrium, bismuth, zinc, cerium, aluminum, silicon, calcium, rare earth elements, and magnesium.

17. The method according to claim 12, wherein the first coating composition further comprises (iii) free fluorine and (iv) a metal fluoride salt formed from a metal which forms a fluoride salt; wherein the metal that forms the metal fluoride salt is supplied in an amount sufficient to maintain the level of free fluorine in the first coating composition at a level ranging from 0.1 ppm to 300 ppm based on the total weight of the first coating composition.

18. The method according to claim 12, wherein the (i) group IIIB or IVB metal comprises zirconium, titanium, hafnium, yttrium, cerium, or combinations thereof.

19. The method according to claim 12, wherein said second composition further comprises (ii) a copper compound.

20. The method according to claim 19, wherein the copper compound (ii) is a water soluble copper compound.

21. The method according to claim 19, wherein the copper compound (ii) is elemental copper present at a level ranging from 1 ppm to 5,000 ppm based on the total weight of the first coating composition.

22. The method according to claim 12, wherein the first coating composition is substantially free of phosphate ions.
